(19) United States
(12) Patent Application Publication
(10) Pub. No.: US 2011/0033254 A1
(43) Pub. Date: Feb. 10, 2011

(54) System And Method Of Locating Relative Positions Of Objects

(75) Inventor: Charles A. Abrams, St. Clair Shores, MI (US)

Correspondence Address: DICKINSON WRIGHT PLLC, 1875 Eye Street, NW, Suite 1200, WASHINGTON, DC, 20006, US

(73) Assignee: KMT ROBOTIC SOLUTIONS, INC., Auburn Hills, MI (US)

(21) Appl. No.: 12/536,794

(22) Filed: Aug. 6, 2009

(51) Int. Cl. B23B 35/00; B26D 1/00; G06F 15/00

(52) U.S. Cl. 408/1 R; 83/13; 702/152; 901/2; 901/47

(57) ABSTRACT

An apparatus and method for performing manufacturing operations using position sensing for robotic arms that efficiently and accurately finds the location of a workpiece or features on a workpiece, with minimal need for adjustments.

### BACKGROUND OF THE INVENTION

### 1. Technical Field

The present invention relates to an apparatus and method for determining a position of an elongated large workpiece such as a windmill or wind turbine blade with a robotic assembly before performing a manufacturing operation, and a method of performing a manufacturing operation on the workpiece. More specifically, the present invention is directed to an apparatus and method for quickly and accurately determining the three-dimensional position of the workpiece, a desired location on the workpiece, or the start of a manufacturing operation on the workpiece using a search strategy that eliminates or reduces the need to reposition the workpiece relative to the machine or robot performing the manufacturing operation, particularly useful for cumbersome large and heavy workpieces, such as wind turbine blades.

Robotic assemblies are commonly used in manufacturing to perform a variety of operations including welding, cutting, trimming, drilling, and other shaping and manufacturing operations. Robotic assemblies in manufacturing facilities are commonly used with individual work cells, but also may be arranged along an assembly line. As a workpiece passes down an assembly line or is placed within a robotic work cell, before the robotic assembly performs a manufacturing operation on the workpiece, the robotic assembly must first be calibrated to the workpiece. Typically, the workpiece will be held within a jig or other structure, fixing its dimensions relative to the robotic assembly during the manufacturing operation in an identical position to a master part. More specifically, the robotic assembly is initially calibrated with a master part placed within the jig and the relevant dimensions of the workpiece, such as position of the workpiece or position of a feature on the workpiece is entered. The locations and dimensions operations to be performed are also added to a controller that controls the robotic assembly. Of course, any known method of adding a master part or workpiece, dimensions, or operations to be performed to a controller may be used. Once the initial calibration or entry of the master part is completed, the robotic assembly is used to perform repetitive manufacturing operations on identical or substantially identical workpieces. The subsequent workpieces being held by a jig or other fixture, travel along an assembly line or are individually placed within the work cell of the robotic assembly so that the robotic assembly may perform a desired manufacturing operation. For most robotic assemblies, and in particular for robotic assemblies along assembly lines, such as for welding robots, the workpieces are dimensionally stable, the workpieces are not large, heavy or elongated and therefore are easily and repetitively placed accurately in the jig or cell in the precise or sufficiently within tolerances that match to the previous location of the master part. The manufacturing operation may also have a large error tolerance, thereby allowing for more variation in placement of the part and also minimizing the frequency of calibration required. For example, once calibrated to a particular workpiece, a welding robot on a vehicle body assembly line will rarely need recalibration to that particular workpiece.

For many robots, the only recalibration needed to accurately determine the location of the workpiece in order to perform a manufacturing operation within the desired manufacturing tolerances is for the robotic assembly to recalibrate by touching a sensor on the robotic assembly such as a sensor on its arm, as the workpiece is generally easy to precisely place in the same position as the master part within the jig. Once the robotic assembly is recalibrated, typically between a set number of workpieces or before each workpiece, the robotic assembly starts the manufacturing operation.

Some workpieces on which manufacturing operations are performed require a high degree of accuracy in the performed operation, are not dimensionally stable, inconsistently vary from an expected position, are cumbersome, heavy, or of a nature that is hard to precisely locate within the work cell, or a combination of these factors, requiring the robotic assembly to be calibrated specifically to each workpiece, before the start of a manufacturing operation. For workpieces which are not dimensionally stable, during the manufacturing operation, the robotic assembly may also need to recalibrate itself to the workpiece between manufacturing steps. Each calibration to a particular workpiece is time consuming, thereby reducing the speed of a manufacturing operation. To adjust for movement of the workpiece relative to the jig or fixture, robotic assemblies typically use a digital sensor to find an edge feature or similar variation on the workpiece to determine the location of the workpiece. For some parts, two or more features are found to locate the workpiece. In determining that a workpiece is accurately positioned, or determining the actual location of the workpiece, the robotic assembly checks the position of a specified point or points on the workpiece for any variation relative to the location of the position(s) on the initial calibrating workpiece. With the article or workpiece sufficiently located, and the robot calibrated to the actual workpiece, the robot switches from the sensor to a tool and the manufacturing operation generally proceeds.

For extremely large or heavy workpieces, as well as cumbersome workpieces, material handling problems also affect accurately positioning the workpiece. For example, modern large windmill or wind turbine blades may range from 10 meters to over 80 meters long, 1 meter to 5 meters around, and 5,000 kilograms to 20,000 kilograms. To accurately move and position these blades in a jig or fixture is very difficult, and it is almost impossible to accurately and precisely fix the workpiece, on which the manufacturing operations are to be performed, within a jig at the same position as the master part when the machine was calibrated. More specifically, for such cumbersome, large and heavy workpieces, heavy equipment is needed to move and position the workpiece, and such heavy equipment is generally not configured for precise or accurate placement of workpieces or minute movements of workpieces. In addition, for large windmill blades, it is very important that the machining of a hub face at the root end of the blade and the drilling of holes for an attachment mechanism at the hub face be accurate and precise. Any minor inaccuracies may have severe and costly consequences during assembly and operation of a windmill. For example, a minor variation in the machined surface of the hub face may not show up until installation, operation or especially operation of the windmill in high winds. All of these would necessitate a field replacement of the blades. Not only are the blades expensive, but the transportation to the installation site, many times a remote, hard to reach site, as well as removal of the defective blade and installation of the new blade with a crane is very costly. In fact, many times the removal of a defective blade and installation of a new blade far exceeds the cost of the blade. Therefore, it is extremely important to accurately position these workpieces during manufacturing and subsequent machining operations, however such accurate placement is extremely difficult. In addition, most wind turbine blades are formed of a composite material, which commonly may vary from the master part and vary with each workpiece, making it difficult to accurately and precisely machine the surfaces.

Using a digital sensor to find the workpiece or a position on the workpiece is time consuming or at times inaccurate. For example, if the workpiece is substantially shifted within the jig, it may be difficult for the digital sensor to find the desired calibrating feature, such as an edge of the workpiece. Digital sensors generally require a 3-dimensional surface change to identify an edge or feature on the workpiece. Even if the robotic arm eventually finds the workpiece with the digital sensor, the process may be time consuming because the robotic arm has to place the digital sensor at a starting point and then move the sensor a sufficient distance across the feature to detect the sharp 3-dimensional surface change. This moving of the digital sensor to detect a feature is time consuming as the digital sensor must not only be moved slow enough to ensure an accurate reading of the exact location of the feature but also must be moved for a distance sufficient to account for all variations in location of the workpiece or in particular the feature. Therefore, the sensor start location is set back sufficiently from the expected feature position, so that the location of the workpiece or feature may be found no matter the position within a jig. If further dimensions must be determined before starting a manufacturing operation, repeating the above-described operation to find one or two more features requires valuable time in the manufacturing operation and reduces potential productivity. Therefore, there is a need for a robotic assembly that includes a method of sensing features on a workpiece or the position of a workpiece to perform a manufacturing operation in a more time efficient manner.

Another problem with present known methods of determining workpiece or feature locations is that articles or workpieces such as parts formed from fiberglass, plastic, or other similar materials may not be dimensionally stable while the manufacturing operation is being performed. Therefore, while the time consuming process of locating the workpiece or a feature on the workpiece is performed, the workpiece may shift, move, or shrink. This movement may even occur as the manufacturing operation is performed thereby causing inaccuracies in the manufacturing operation being performed on the workpiece. For example, in performing trimming, cutting, or drilling operations on a fiberglass part such as a large hot tub or boat, the workpiece may shrink during the manufacturing operation. The workpiece may also shrink unpredictably at different rates in different locations on the workpiece. One cause of variable shrinking of a workpiece is the thickness of the material. Some workpieces have a thickness which may randomly vary within a specified range, making the rate of shrinkage difficult to control or predict. For example, a workpiece may have a long extent within a thin thickness, which would have a high rate of shrinkage and a shorter extent with greater thickness, which would have a lower rate of shrinkage. Due to the unpredictability of the shrinkage rates, these variations cannot be accounted for when calibrating the robotic assembly. Therefore, if a large number of holes need to be drilled or extensive cutting operations need to be performed, as the robotic assembly proceeds with its manufacturing operation, the difference between the expected location of operation and actual location may increase, making the workpiece unusable.

Therefore, there is a need for a robotic assembly that quickly and accurately finds the workpiece, in particular long or heavy workpieces with minimal movement of the workpiece to allow an accurate and precise manufacturing operation to be performed.

### SUMMARY OF THE INVENTION

In view of the above, the present invention relates to an apparatus and method for determining a position of a workpiece with a robotic assembly before and as needed during manufacturing operations, with minimal positioning movement of the workpiece needed to ready the workpiece for manufacturing operations. More specifically, the present invention is directed to an apparatus and method for quickly and accurately finding the location of a workpiece, a desired position on a workpiece or the start of a manufacturing operation using an iterative search strategy. Furthermore, the present invention also allows for adjustments or updates to the relative position of the workpiece due to movement or shrinkage during the manufacturing operation. The method and system is also configured to adjust the robot assembly to the location of large workpieces with minimal need to precisely and accurately place the workpiece.

The method generally includes the steps of directing an analog sensor to a first measurement position, based upon an expected location of a first surface of the workpiece. The analog sensor then senses a first surface or feature on the workpiece to determine the actual location of the first surface or feature along at least one axis. With the location of the first surface or feature on a workpiece known, an expected location of a second surface or feature on a workpiece is determined. The system moves the sensor to a second measurement position, based upon the determined first measurement position. The system then senses the actual location of the second surface or feature on the workpiece. The method may further include additional steps for finding additional features or surfaces on the workpiece. The manufacturing operation proceeds once the location of the workpiece, feature, or position of the start of the manufacturing operation is sufficiently determined.

The method may also use a digital sensor in combination with an analog sensor. To ensure maximum efficiency and that a digital sensor does not miss or misinterpret a feature or surface, the analog sensor is used to find the first surface or feature on the workpiece. With the actual location of the first surface or feature determined, the system determines a second measurement position at least in part using the actual determined location of the first surface or feature. The digital sensor may be used in place of the analog sensor subsequent to the first measurement.

The system for large workpieces includes a 3-D visualization system, such as a 3-D camera to determine the relationship of the end of the workpiece that is remote from the robotic assembly and a sensor array located between the 3-D visualization system and robot assembly to determine twist of the workpiece from the zero axis position. Using a position sensor, typically a laser displacement sensor on the robot and the two remote sensors at different distances from the robot assembly in combination with an iterative search strategy allows a search strategy that quickly, accurately and precisely determines the position of a large workpiece and allows the robotic assembly to adjust its view of the workpiece to match its view of the master part, in place of adjusting the workpiece to the proper position within a jig or moving individual components of a large machine to match the workpiece. More specifically, based upon information from the remote sensors, the position sensor on the arm of the robot assembly may quickly find the desired location.

The present invention is directed to a method of performing a manufacturing operation on an elongated workpiece having an outer circumference and an inner circumference at a root end using a robotic assembly, the robotic assembly including a robotic arm, a first remote sensor capable of sensing twist and a second remote sensor, at least one sensor located on the robotic arm, and a controller, the method includes the steps of: (1) directing the sensor on the robotic arm to a first measurement position based upon an expected location of a first location of at least one of the outer circumference and an inner circumference of the workpiece; (2) sensing the actual location of the first location on the workpiece using the sensor on the robotic arm; (3) communicating the output of the sensor on the robotic arm to the controller to determine the actual location of the first location of the workpiece; (4) determining with the controller an expected location of a second location on at least one of the outer circumference and inner circumference of the workpiece using the actual location of the first location on the workpiece; (5) moving the sensor on the robotic arm to a second measurement position, the second measurement position being determined by the expected location of the second location of the workpiece; (6) sensing the actual location of the second location on the workpiece using the sensor on the robotic arm; (7) communicating the sensor output of the sensor on the robotic arm to the controller to determine the actual location of the second surface of the workpiece; (8) calculating the actual root end center of the elongated workpiece; (9) determining the twist of the workpiece; and (10) determining the location of tip of the elongated workpiece. At least three surface locations are determined before the actual center point fits within a desired range. Of course, the system may perform “n” measurements before stopping.

The present invention is also directed to a method of performing a manufacturing operation on a wind turbine blade having a longitudinal axis, a tip, an outer circumferential surface, an inner circumferential surface defining a cavity, and a root end, using a robotic assembly, the robotic assembly including a robotic arm, a first remote sensor capable of sensing twist and a second remote sensor, at least one sensor located on the robotic arm, and a controller, the method comprising the steps of: (1) directing the sensor on the robotic arm proximate to a first measurement position proximate to the root end based upon an expected location of one of the outer circumferential surface and the inner circumferential surface; (2) sensing the actual location of a first location on the at least one of the outer circumferential surface and the inner circumferential surface proximate to the root end using the sensor on the robotic arm; (3) moving the sensor on the robotic arm proximate to a second measurement position; (4) sensing the actual location of a second location; (5) determining a first estimated root end center based upon the actual location of the first and second locations; (6) continue measuring additional locations on at least one of the surface of the outer circumference and the surface of the inner circumference; (7) determining based upon the additional locations additional estimated root end centers, until the last estimated root end center is within a specified tolerance level; (8) determining the twist of the workpiece; and (9) determining the location of tip of the elongated workpiece. Of course, the sensor may also use a third location for measurement and determination of the root end center.

The present invention is also directed to a method of performing a manufacturing operation on a wind turbine blade having a longitudinal axis, a tip, an outer circumferential surface, an inner circumferential surface defining a cavity, and a root end using a robotic assembly, the robotic assembly including a robotic arm, a first remote sensor capable of sensing twist and a second remote sensor, at least one sensor located on the robotic arm, and a controller, the method comprising the steps of: (1) determining the twist of the workpiece using the first sensor; (2) determining the location of the tip of the workpiece using the second sensor; (3) determining an estimated location of one of the outer and inner circumferential surfaces using the determined twist and determined location of the tip of the workpiece; (4) directing the sensor on the robotic arm proximate to a first measurement position proximate to the root end based upon the determined estimated location of one of the outer and inner circumferential surfaces; (5) sensing the actual location of the a first location on the at least one of the outer circumferential surface and the inner circumferential surface proximate to the root end using the sensor on the robotic arm; (6) determining with the controller an expected location of a second measurement position on one of the outer circumferential surface and the inner circumferential surface of the blade proximate the root end using the actual location of the first location; (7) moving the sensor on the robotic arm proximate to the second measurement position; (8) sensing the actual location of the second measurement position; (9) determining a first estimated root end center based upon the actual location of the first and second measurement locations; (10) continue measuring additional locations on at least one of the surface of the outer circumference and the surface of the inner circumference; and (11) determining based upon each of the additional locations additional estimated root end centers, until the last estimated root end center is within a specified tolerance level. Of course, the system may sense the location of third surface from a third measurement position, which will help in determining more accurately the root end center.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 illustrates a schematic of the robotic assembly;

FIG. 2 illustrates a first analog search;

FIG. 3 illustrates a first and second analog search;

FIG. 4 illustrates an analog and digital search;

FIG. 4A illustrates the search patterns on the top surface of the workpiece illustrated in FIG. 4;

FIG. 5 illustrates the use of offset searches;

FIG. 6A illustrates the locations of iterative searches;

FIG. 6B illustrates an exemplary location of first searches on a rotated workpiece;

FIG. 6C illustrates a second iteration of searches on a workpiece;

FIG. 6D illustrates a final iterative search of a workpiece;

FIG. 7A illustrates a search of a workpiece in an expected measurement position;

FIG. 7B illustrates a problematic search with the workpiece offset from the expected position;

FIG. 8 illustrates the shrinkage of an exemplary workpiece;

FIG. 9A illustrates a first exemplary search pattern;

FIG. 9B illustrates a second exemplary search pattern;

FIG. 10 illustrates a top view of a wind turbine blade as a workpiece and locations of the robot assembly and sensor arrays relative to the workpiece;

FIG. 11 illustrates a front view of the workpiece, robot assembly, and sensor arrays;

FIG. 12 illustrates a front view of the end portion of the workpiece showing a search strategy;

FIG. 13 illustrates a partial front view of the middle sensor relative to the workpiece;

FIG. 14 illustrates a sectional view of the workpiece and a side view of the sensor array in FIG. 13;

FIG. 15 illustrates a side end view of a wind turbine blade;

FIG. 16 illustrates an enlarged partial perspective view of the side end edge of a wind turbine blade;

FIG. 17 is a flow chart diagram of an exemplary process; and

FIG. 18 is a flow chart diagram of an exemplary process.

### DETAILED DESCRIPTION OF THE PREFERRED EMBODIMENT

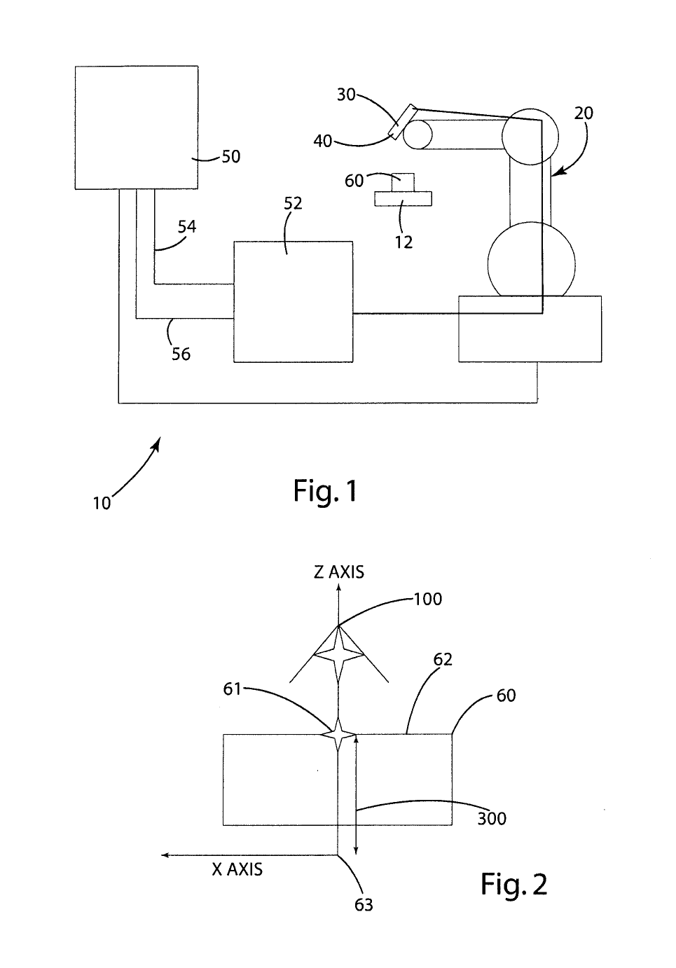

As illustrated in FIG. 1, the present invention is generally directed to a robotic assembly 10 that includes a robotic arm 20, at least one analog sensor 30, a digital sensor 40 and a controller 50 for controlling the movements of the robotic arm 20. The robotic arm 20 is any robotic arm that can position a sensor for measurement, or hold a tool for performing a manufacturing operation.

The robotic arm 20 is illustrated as a six-axis robotic arm, however other configurations of robotic arms and systems may be easily substituted. The size, shape, or configuration of the robotic arm is irrelevant for purposes of the present invention. In some embodiments, a workpiece support assembly 12 may be configured to move in conjunction with the robotic arm 20. Although only a single robotic arm 20 is illustrated in the figures as performing both the functions location of the workpiece 60 and the manufacturing operation, more than one robotic arm 20, such as a different robotic arm for each task may be used without departing from the scope of the present invention. The robotic arm 20 may further include an end effector (not illustrated) that is capable of selecting different tools and sensors. The robotic arm 20 is controlled by a controller 50 as is well known in the art. The robotic arm controller 50 may also control and receive input from the sensors 30 and 40 on the robotic arm 20, as well as remote sensors 70, if applicable, specifically sensors 80 and 90, but as illustrated in FIG. 1, the robotic assembly 10 may include a separate sensor controller 52 in communication with the robotic arm controller 50. The sensor controller 52 receives input from the analog and digital sensors 30 and 40 located on or selected by the robotic arm 20 as well as remote sensors 70, if applicable. The sensor controller 52 provides an output to the arm controller 50 regarding the actual location of workpiece 60. The sensor controller 52 is illustrated as providing and analog output 54 and a digital output 56 to the controller 50, however these outputs may be combined. Furthermore, the sensor controller 52 may perform all calculations and determinations regarding next position of the robot arm and the surface or feature locations, with the arm controller 50 controlling only the movement of the arm based upon input from the sensor controller. Of course, the arm controller 50 may provide all controls, calculations and determinations, with the sensor controller only turning on and off the sensor and providing raw, complied or processed data from the sensors to the arm controller 50. Any known robot controller or sensor controller may be used to implement the method of the present invention and the actual functions of each may be split in any manner without detracting from the present invention. Also the method may be implemented using any known robotic arm or other robotic device for performing manufacturing operations. Although the present invention is described below using a single robotic arm and illustrated as a single robotic arm, multiple robotic arms may be used in the process.

The analog sensor 30 is any analog sensor that has the ability to move with robot arm 20 and be triggered at any desired location. The present invention uses a laser analog sensor, but ultrasonic, infrared, Doppler, or any other analog sensor, including 3-D vision cameras capable providing a distance measurement without contacting the workpiece may be used. While some contact analog sensors exist, they have similar drawbacks to the digital sensor and are very time consuming and inefficient to use. Therefore, the present invention only uses non-contact analog sensors. The analog sensor 30 can provide an analog distance measure without contacting the workpiece 20.

The digital sensor 40 can be any digital sensor capable of non-contact measurement providing a digital trigger point when used to search for a feature, such as an edge of the workpiece 20. Examples of digital sensor are laser, ultrasonic, infrared, Doppler or any other digital sensor providing a digital trigger point regarding a specific desired feature.

The present invention preferably uses one sensor as illustrated in FIG. 1, which combines both the digital and analog sensors 30 and 40 together. In the preferred embodiment, the sensor is a laser sensor that can provide an analog distance output and a digital trigger point regarding specific features. More specifically the sensor provides an analog distance measurement when desired or provides a digital trigger point when desired. These sensors are generally laser measurement devices with dual functionality. Therefore, in operation, the method may provide a single sensor having analog output and digital output. By combining the analog and digital sensors 30 and 40 into a single sensor eliminates the necessity of switching between sensors, which is time consuming and inefficient.

The present invention may use one of two search strategies or a combination thereof for finding the location of workpieces, features on workpieces, or the start of a manufacturing operation on workpieces placed in a robotic work cell or traveling along an assembly line. Exemplary manufacturing operations commonly performed by robotic assemblies include trimming of the workpiece, cutting operations, as well as drilling holes in the workpiece. Of course, the present invention, which includes the method of finding the workpiece, may be used with any robotic assembly that requires an accurate location of the workpiece to perform the desired manufacturing operation. The first method of finding a workpiece uses a plurality of analog searches to locate the workpiece, feature or location of the start of manufacturing operation. The second method of locating a workpiece uses a combination of analog and digital sensors to locate the workpiece, feature, or location of the start of the manufacturing operation. Of course, in some embodiments, the present invention may use a combination of the first and second methods. In performing the methods of locating a workpiece, feature, or start of a manufacturing operation, the present invention may use touch sensors or non-contact sensors, choosing the best-suited sensor for a particular measurement.

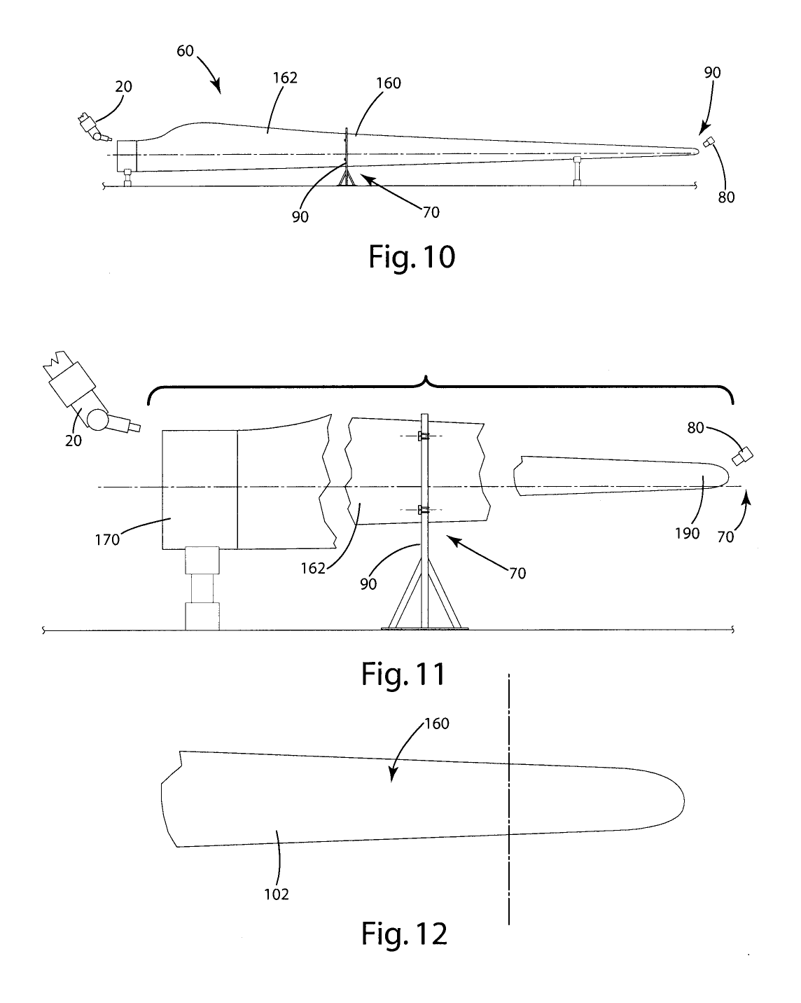

As illustrated in FIGS. 10-16, for larger workpieces the system may further include a 3-D visualization system 80 located at the remote end of the workpiece from the robotic assembly 10 and a sensor array 90 located therebetween.

Before any manufacturing operation may be performed, the robotic assembly must be calibrated. In some embodiments, the calibration to a master workpiece may be entered without any actual measurements by the particular robotic arm, however, most robotic assemblies still use a master workpiece and physically calibrate the robotic assembly to the master workpiece. The purpose of calibration is to both provide the robotic assembly with the details of the expected location of subsequent workpieces as well as where on the workpiece particular manufacturing operations is to be performed. For example, in creating the master workpiece data file which is generally stored in the controller 50, the subject data is loaded into the controller by the robotic arm either learning physically where the workpiece is or being digitally provided with the expected location of the workpiece or features on the workpiece. Any method of providing a calibration of the master workpiece or part may be used to provide the controller 50 with the necessary information to perform the manufacturing operation. The present invention is specifically directed to the finding of the part both before and during the manufacturing operation and is not directed to providing calibration or inputting of the master workpiece data.

Once the robotic assembly is calibrated to a particular workpiece or feature by identifying data at selected measurement points and that data is placed within the controller's memory, subsequent workpieces or features may be found using this data to determine expected locations for measurement. In the first method and as exemplary illustrated in FIG. 2, the robotic assembly directs an analog sensor 30 on the robotic arm 20 to a first measurement position 100 based upon an expected location of the first surface 62 of the workpiece 60. As illustrated in FIG. 2, due to various differences between the workpiece, location of the workpiece within a jig, or even position of the jig, the workpiece may be offset from its expected location. This first offset is illustrated in FIG. 2 as showing the expected location from the master workpiece origin versus the actual location origin of the workpiece being measured. The location of the measured position of the first surface is illustrated by the star 61 along the first surface 62 of the illustrated workpiece 60. The difference between the location on the workpiece illustrated by the star 61 and the master origin 63 is a one-dimensional offset 300 and in this case is illustrated as being an offset along the Z-axis as the robotic arm assembly is determining the height or depth of the workpiece 60.

The use of an analog sensor 30 to provide the first search for the workpiece is useful because analog sensor 30 may easily find surface locations of parts without movement of the sensor and without contacting the workpiece. Given the magnitude of offset that may occur between the expected workpiece or feature location and the actual location, digital sensors may be time consuming to find the initial location of the workpiece or may easily miss the workpiece entirely. Therefore, the analog sensor 30 easily finds the workpiece, even if the workpiece is substantially offset.

With the actual location of the first surface or feature 62 of a workpiece along a first axis found, the controller 50 may direct the robotic arm 20 and associated sensor to a second measurement position 102. The second measurement position 102 may be based upon the expected location of the particular feature or master workpiece surface to be measured. However, it is preferable to update the location of the workpiece along the axis already measured within the controller 50 based upon the actual location of the first surface measured from the first measurement position 100. More particularly, the analog sensor 30 in the first measurement position 100 senses the actual location of the first surface of the workpiece 60. Typically the analog sensor 30 may do this without movement for a quick and accurate location of the first surface 62 of the workpiece 60. This sensor output is communicated to a controller which determines the actual location of the first surface 62 of the workpiece 60 including the offset of the actual location from the expected location to determine the one-dimensional offset 300 distance along an axis as illustrated in FIG. 2 along the Z-axis. The controller 50 then directs the robotic arm 20 and the analog sensor 30 to a second measurement position 102. By updating the second measurement position 102 based upon the actual location of the first surface 62 of the workpiece 60 or location of a first feature on a workpiece, the sensor is better positioned to obtain a more accurate reading quicker. In some embodiments, without updating the second measurement position 102, the sensor may miss the workpiece entirely.

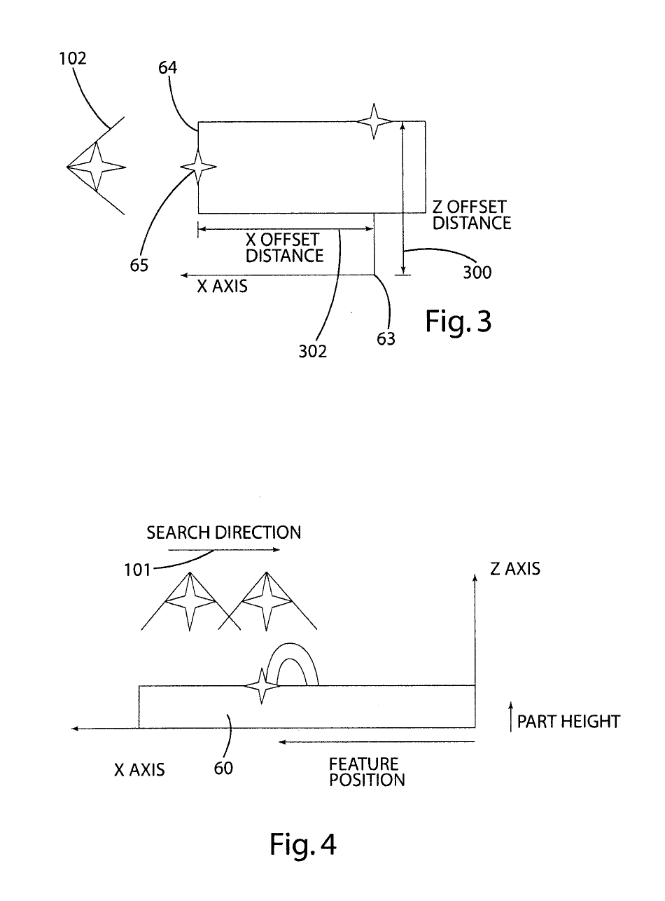

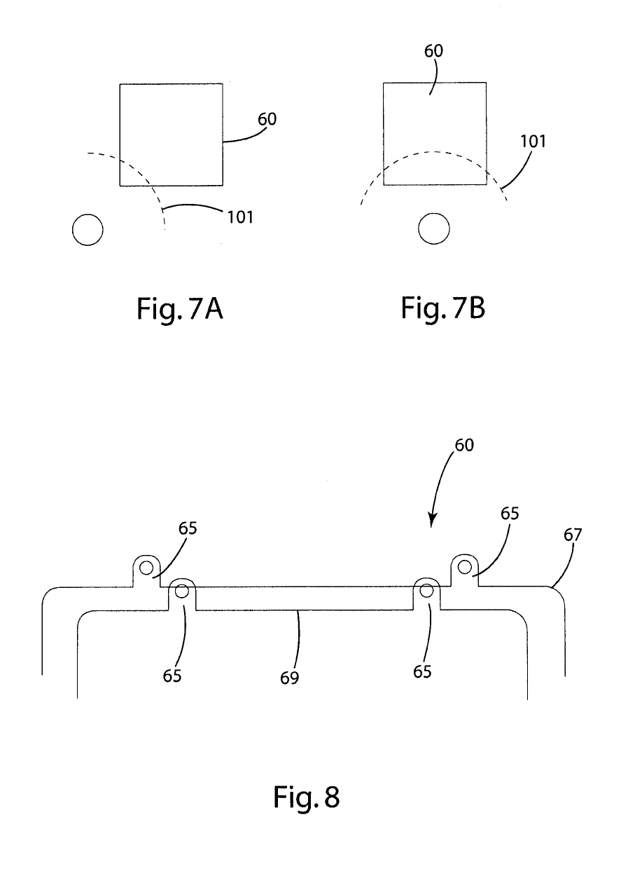

With the analog sensor 30 moved to the second measurement position 102, a second measurement is taken by sensing the actual location of the second surface 64 at the star 65 with the analog sensor 30. The data from the analog sensor 30 output is then provided to the controller, which determines the actual location of the second surface 64 of the workpiece 60 as illustrated in FIG. 3. More specifically, the sensor 30 determines a second offset distance 302 from the expected location based upon the master workpiece origin 63 from the actual location of the second surface 64. In FIG. 3, the second dimensional offset 302 measurement is being illustrated as the offset along the X-axis. With the location along two axes found, in some instances the manufacturing operation may proceed. However, although not illustrated, it may be preferable to repeat the measurement with the analog sensor along a third axis or more to determine the difference between the expected location of a third surface (not shown) of the workpiece 60. Determining additional locations, surfaces or features beyond the above-discussed first two measurements provides for greater accuracy in finding the location of the workpiece, feature, or start of a manufacturing operation. In some embodiments, a rotational measurement may also be determined, as illustrated in FIGS. 7A and 7B. FIGS. 7A and 7B further illustrate a sensor sweep path 101 and the problems if the workpiece is misaligned with the robotic arm 20. For example, in 7A, the sweep finds two adjacent edges, but if the workpiece is moved relative to the arm as illustrated in FIG. 7B, the sweep finds two opposing edges. Therefore, once the workpiece is at least partially located along one or two axes, the robotic arm 20 may perform the seep 101, which would provide additional information regarding the rotation of the workpiece or particular features, as well as additional location information.

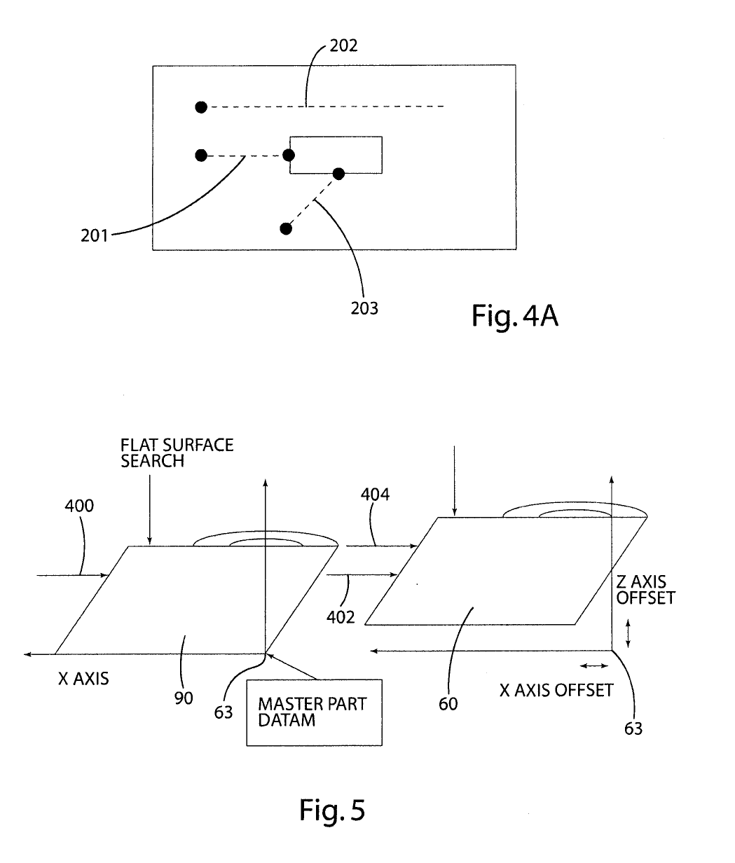

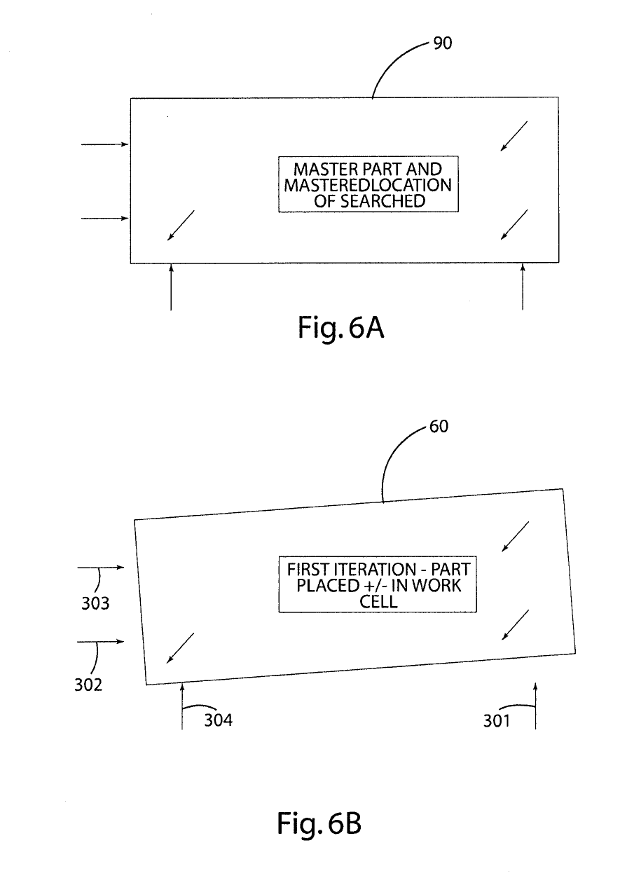

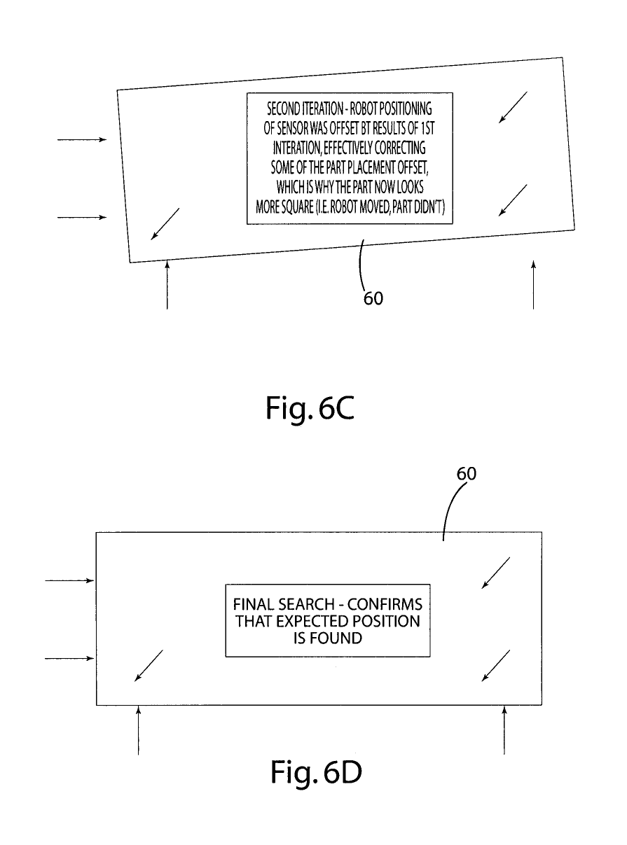

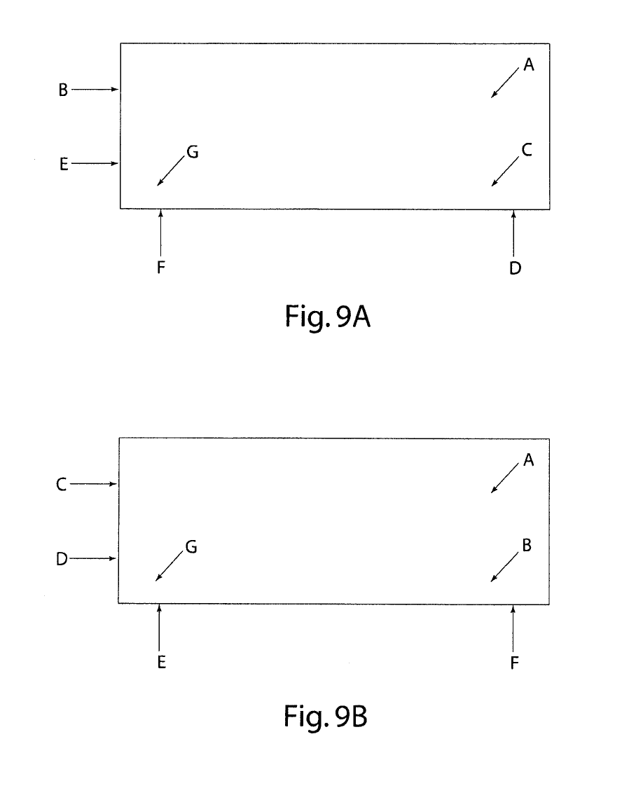

Multiple measurements may also be performed along a particular axis as illustrated in FIGS. 6A-6D. The particular order of a search strategy may vary as illustrated by the exemplary search patterns in FIGS. 9A and 9B. The chosen pattern may depend on the expected location error in placement of a workpiece, such that all measurements are completed on a particular axis or one is completed on each axis to initially locate the workpiece. While the measurements are being shown taken along planar surfaces, various other measurements may be used with the analog sensor to determine the offset distance along a first axis and second axis or the offset along a first, second, and third axis. The searching may be done for only a feature on the workpiece or features on the workpiece such as illustrated in FIGS. 4-5. For example, when a large boat shell is trimmed or holes are drilled for passage of various items such as electrical wiring, fuel lines and supports for cleats, the location for each manufacturing operation must be determined. As a large shell such as a fiberglass hull may vary widely, the robotic assembly may determine the location of a feature of the boat shell near to the expected manufacturing operation. Therefore, instead of locating the complete shell of the boat and performing manufacturing operations based upon the overall location of the shell of the boat, instead smaller features on the boat are found and individual manufacturing operations are performed based upon the location of these features to provide a more accurate result in the manufacturing operation. Furthermore, as the manufacturing operation proceeds, the sensors may be used to update in real time the location of the robotic arm versus the surface and a controller can provide corrections during the manufacturing operation. If the workpiece 60 is shrinking during a manufacturing operation, as illustrated in FIG. 8, the individual updates may allow the system to account for this shrinkage as the manufacturing operations are performed. The workpiece illustrates a first size 67 that shrinks to a second size 69. As further illustrated in FIG. 8, the location of the features 65 move.

As illustrated in FIGS. 6A-6D, measuring many one-dimensional or 1D shifts allow the system to define many positions around a workpiece and thereby get an accurate location of the workpiece. The multiple analog search distance readings are useful in finding multiple 1D shift points around a workpiece that does not hold its shape such as it tends to bow or otherwise change shape. By defining the various part locations using these multiple 1D distance measurements, the robots cutting path may be changed to accommodate different shaped workpiece that vary from the master workpiece.

The search strategy may be further improved in the second method by combining a digital sensor with the analog sensor to find features on a workpiece or edges of the workpiece. Digital searches are very useful in finding sharp edges or specific features on a part. The problem with digital searches being very time consuming to perform is overcome when an analog search is combined with the digital search. Therefore, once the analog search is performed as described above, along at least one dimension, the digital search is performed as the general location of the workpiece is now known. Of course, performing the analog search along multiple dimensions will provide a more accurate location for the digital search to start from thereby in many instances reducing the amount of time required to accurately perform the digital search. Therefore, after performing an analog search as illustrated in FIG. 1 or in FIGS. 2 and 3, the robotic arm assembly may perform a digital search as illustrated in FIG. 4 to find a feature position, or the edge of a part. A feature may be any feature that has a measurable variance such as an eye hole illustrated in FIG. 4. By first providing the general location or an area of a workpiece with analog sensor it is more likely that the digital sensor will quickly find the eye hole or other feature. For example, if a part is both slightly rotated and shifted, the digital sensor may miss the eyelet completely or find it at a wrong location as further illustrated in FIG. 4A. More specifically, the desired search pattern with a digital sensor is illustrated as the dotted line 201. Search 201 is the accurate search that finds the start of the eyelet and by first locating the position of the workpiece, the system ensures that the digital search is efficient and accurate. However, if the workpiece is slightly offset along one of the axes, a search similar to that in dotted line labeled 202 in FIG. 4A may be performed, which would never find the eyelet. If the part is offset and slightly rotated, the dotted line search 203 illustrates finding the wrong position of the eyelet which would cause an inaccurate location for the desired manufacturing operation. After finding a feature location with the digital sensor, the manufacturing operation may be performed.

For small, thin, flat parts that are very consistent in size and shape, finding the three dimensional shape of the part is typically first performed by an analog search, such as to find the top surface and then using the digital sensor to find two edges of the part. If the top surface has any height changes within it, then a digital search may be first performed to find an edge so that the analog search occurs within the right location on the top surface such that the potential for height variations to undesirably affect the analog sensor is minimized.

For many parts it is also preferable to offset searches using data from the other searches to accurately find the location of a surface. For example, when multiple operations are performed to a large workpiece, the location of one feature provides data for the controller to change the location of the first measurement position for the next location to be determined. More specifically, if the workpiece is found to have a large longitudinal shift, the next search will start from an updated first measurement position that takes the longitudinal shift into account. Therefore, each subsequent search for a particular location starts for a more accurate first measurement position thereby each time a search is performed, it occurs more quickly and accurately than the last search. Another example is when a workpiece or feature on a workpiece moves by rotation, it may be difficult to get an accurate search. Furthermore, when a workpiece is tapered such as the workpieces illustrated in FIG. 5, a search to determine the offset along the X-axis may significantly vary. Therefore, as illustrated in FIG. 5, a search is performed in the X direction to find the angled surface to determine the rough location of the part. With the part found, a second search can be performed to find the offset of the flat surface along a second axis such as the Z-axis. Now, with the two searches providing known locations, there is a good reference point to perform a third search along the same axis as the first search to determine the actual location of a particular point on the first surface. As illustrated in FIG. 5, the third search in the offset part is performed relative to the part at the same location as it would be done on the master search. In the illustrated FIG. 5, it is important to note that the first master search 400 along the angled surface in the master workpiece 90 on the left is performed at the same location as the subsequent search 404 relative to the workpiece 60. However, it can be seen relative to the origin 63 that the first workpiece search 402 did occur at the same position as the first master search 400 relative to origin 63.

Further iterative searches may also be performed that provide greater detail and precision and accuracy of finding the workpiece in three dimensions or 3D, yet also accounting for rotation of a workpiece. While a one-dimensional rotation of a workpiece may be easy to determine, it is more difficult to determine a two dimensional and three dimensional rotation of a workpiece. Three-dimensional rotation of a workpiece is particularly important to objects that vary in shape and size such as a hot tub or boat hull that is shrinking as it is cooling shortly after being formed. Furthermore, large workpieces may also have features that are three dimensionally shifted relative to the overall workpiece such as assembled workpieces and while the workpiece may be easily found, the feature may be needed to be three dimensionally located as well as determine if there is any rotation three dimensionally. More particularly, these workpieces are typically repeatable in size and shape but can not be located repeatably within a work cell. Typically this means placement plus or minus one inch in each axis.

The key to finding a whole workpiece accurately and finding the rotation of the workpiece is to search locations that were searched on the master part. Therefore, as illustrated in FIG. 6A, a master workpiece is placed within the work cell and searched to provide master location data. As further illustrated in FIG. 6B, the actual workpiece is placed within the work cell and a first iteration of searches is performed. The rotation of the workpiece may be seen relative to the robot assembly as it would be viewed in comparison to the master part it is important to note that the arrows have stayed relatively constant while the part has shifted because the robot shifts its view of the part, not that the part actually shifts. Therefore, the search locations are being performed by the robot arm in the precise locations that were used on the master part and the robot may update these positions by moving relative to the part and re-perform the same searches, such that it looks as if the workpiece is moving even if it is not. The large offset of some searches may cause problems in finding the part such as searches labeled 301, 302, 303, and 304. In the second iteration, the robot repositions the sensor based upon the results of the first iteration searches to effectively correct some of the part placement offset. Therefore, in FIG. 6C, the workpiece is illustrated as being relatively more square or more aligned with the master part, i.e., the robot moved to accommodate the shift in the part. Therefore, in the second iteration of the searches, the searches will be performed in a closer proximity to the locations that the searches were performed on the master part. Once the second iteration of searches is performed, the robot may perform additional iterations of search until it is satisfied that the part is accurately located and that the search as performed on the workpiece are performed in almost exactly the same locations as those performed on the master workpiece. FIG. 6D shows a final search that confirms the expected position is found and illustrates the arrows pointing to the search locations as being in the same spot as the original master data. These iterative searches may be used also to find features on a workpiece as well as to find three-dimensional shifts of a workpiece. Multiple searches may be performed to first locate the workpiece and then locate the feature. The illustrations in FIGS. 6A-6D are fairly simplistic and the search method does not require the searches to be performed in the location shown and the search locations may be chosen based upon any desired search strategy or number of search locations. As one skilled in the art would recognize, more or less searches may be performed than illustrated in FIGS. 6A-6D. Furthermore, the robot assembly may be satisfied that the workpiece is completely found with only one set of iterative searches.

Therefore, once a part is programmed into a controller the desired searches are programmed and mastered by the controller to create a master data. The master data is stored within the controller. Typically the master data is made inaccessible to the user to insure that the master data does not become corrupt or changed unless specifically desired. Once the controller is prepared with a full set of master data, the next part or workpiece is located into the system for performing a manufacturing operation such as trimming, cutting, or drilling of holes. The appropriate search program is then run in an automatic mode without interaction from the user. The robot assembly performs each of the searches described above as part of the logic program. The differences found from the master position to the next position are calculated into offsets and the offsets are applied as part of the program to be taken into account during manufacturing operations or if necessary to repeat the original part program with a newly located part. The robot assembly then performs the searches iteratively until it is satisfied that the location of the part is found within certain tolerance parameters. Once the workpiece or part is sufficiently found, the robot assembly starts and performs the manufacturing process.

The above-described method with a few modifications may be used with large workpieces for precise and accurate manufacture operations, substantially without the need to adjust the workpiece to the robot assembly, after initial placement of the workpiece. As described above, for large workpieces, it is difficult to properly align them relative to the robotic assembly. More specifically, for wind turbine blades, a minor difference in forming the hub surface may create a large variation in the position of the tip once the blade is installed on the hub of the wind turbine due to the length and shape of the blade. Of course, any variation is undesirable as it may create further repair and maintenance issues.

The present invention for large workpieces, or heavy and difficult to position workpieces uses a robot assembly 10 in combination with at least two remote sensors 70, located remotely from the robot assembly. As illustrated in FIG. 10, the remote sensors 70 include at least one three-dimensional visual sensor or a digital 3-D laser profiling device 80, which is capable of yielding a 3-D map of the workpiece such as, 3-D laser vision camera, and at least one sensor array 90, such as the illustrated analog laser sensor array, or an infrared or ultrasonic sensor array located between the three-dimensional sensor 80 and the robot assembly 10. The sensor array 90 is typically located about two-thirds the distance from the robot assembly 10 to the three-dimensional sensor 80, although variations from such position may be allowed. Although not illustrated, various workpiece supports may be used to position and support the workpiece. Once the workpiece is approximately positioned, the system uses the remote sensors 70 and the sensors 30, 40, specifically the analog sensors 30 on the robotic assembly 10 to calibrate the robot to the workpiece 60, 160.

The present invention allows easy, accurate and precise manufacturing operations to be performed on a large workpiece 60, such as the illustrated wind turbine blade 160. The illustrated wind turbine blade 160 includes an outer contoured surface 102, that forms generally an outer circumferential surface and has a first end 170, such as the illustrated hub end or root end and a second end 190, such as the illustrated tip on the opposing end. The first end 170 includes a hub attachment surface 171 defined between an inner radius 174 and an outer radius 172. A plurality of bolt holes 176 extend into the workpiece 160 from the hub attachment surface 171. A plurality of cross member holes 178 extend between the inner and outer surfaces 173, 174. To attach the workpiece 160 to a hub (not illustrated) of a wind turbine (not illustrated), the hub bolts 188 are inserted into the bolt holes 176 whereupon a cross member bolt (not illustrated) is inserted into the bolt holes to secure the blade 160 to the hub.

As would be recognized by one skilled in the art, it is very important that the hub attachment surface 171 be accurately and precisely machined. The hub attachment surface 171 sets the location of the blade 160 relative to the wind turbine and in particular the support pole of the wind turbine. The hub attachment surface 171 also sets the blade position relative to the other blades to ensure balanced operation of the blades, particularly at rotational speed. The twist of the blade must also be determined for efficient operation. Previously, manufacturers spent hours properly aligning each blade 160 to the proper position, whereas the present invention allows the robotic assembly to align itself to the blade, minimizing the adjustment of the blade itself before and during the manufacturing process. More specifically, by using the present invention, the workpiece 160 only needs to be approximately placed in position, eliminating the need for multiple alignment adjustments that are normally required. While the robot assembly 10 may adjust for variation in the position of the workpiece 160, it is generally more efficient if the workpiece is placed within some predetermined tolerance, but nowhere as close as was previously required. More specifically, previously, the workpiece 160 needed to be placed within ±2.5 mm on each of the x, y, and z axis at both ends of large elongated positions, which was difficult due to the use of heavy machinery required to move large workpieces, which are not typically designed for minute movements. In comparison, the present invention allows the workpiece to be placed within tolerances of approximately ±100 mm or more on each end from the x, y, and z axes, as well as approximately ±2.5 degrees rotation. The operator may verify the workpiece placement before initiating a process cycle.

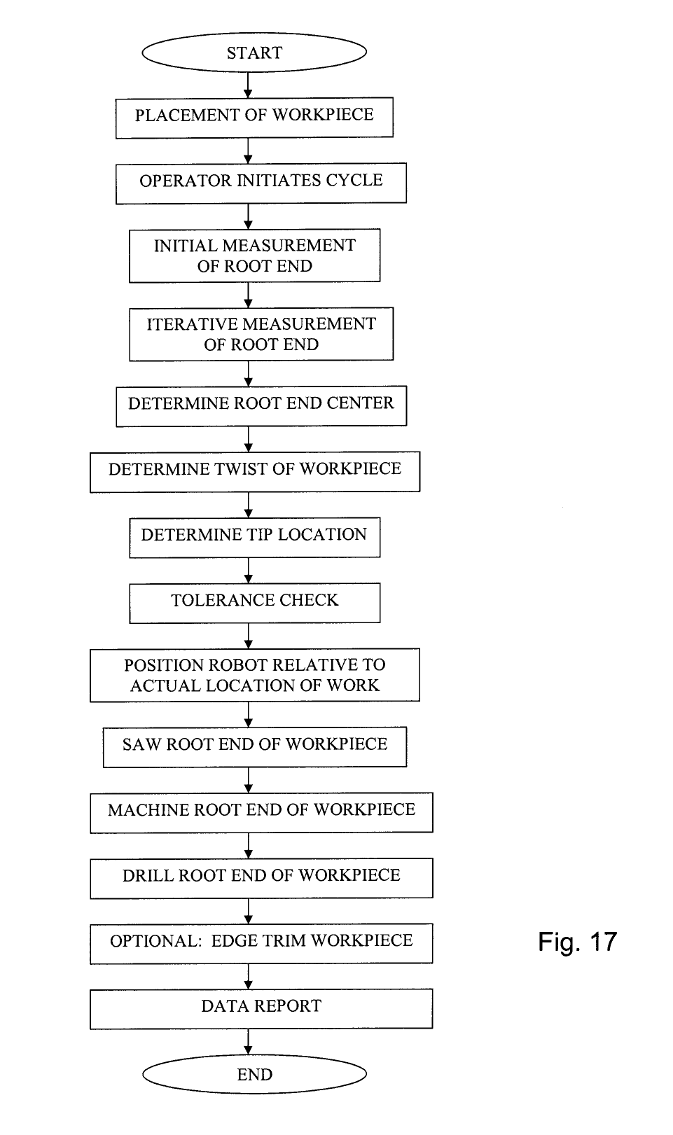

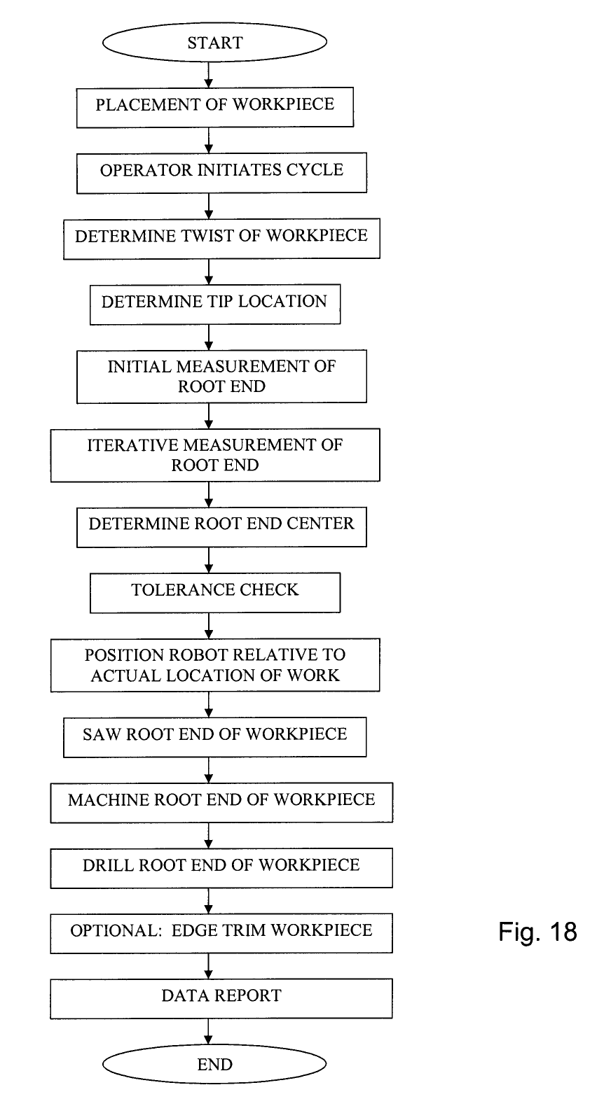

To align itself to the blade 160, the robotic assembly 10 uses the remote sensors 70 as well as at least one of the sensors 30, 40 on the robotic arm 20, typically the analog sensor 30. As illustrated in FIGS. 17 and 18, the order with which the sensors operate may vary, or may occur simultaneously. As illustrated in FIG. 17, with the blade placed and the cycle initiated, a sensor 30 or 40 on the robotic arm 20 measures locations on at least three of the outer or inner circumferential surfaces to determine the best-fit center location using an iterative search strategy. While the system could wait for the iterative search strategy to be completed, once a certain tolerance level is reached, the remote sensors 70, particularly the sensor 80 at the tip 190 measures the location of the tip 190. As the sensor 80 is a 3D visualization sensor, some input regarding expected position based upon data from at least one of the robotic sensors 30, 40 on the robotic arm 20 and if desired, the sensor array 90 regarding twist may reduce processing time to accurately find the tip 190 of the blade 160. In comparison, as illustrated in FIG. 18, with the tip 190 found by the remote sensor 80, the search time by the robotic arm 20, sensors 30, 40 may be reduced, in particular of the time of the initial search as well as the number of iterative searches may be reduced.

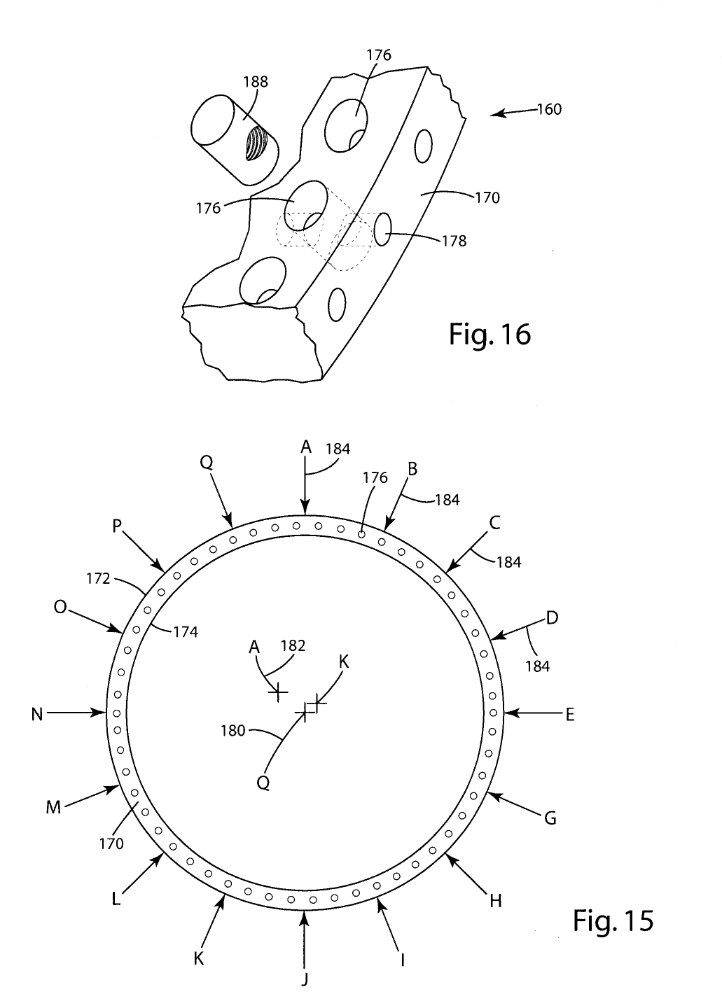

More specifically, the tip end 190, opposite the robotic assembly 10 is found using the remote 3-D visual sensor 80, such as a laser vision device or 3-D camera. If the tip 190 is found first, the system already has a master set of dimensions of the workpiece 160 entered, and the system can calculate the estimated location of the first end 170, near the robotic assembly, and in particular, the radial center, illustrated as 182a in FIG. 15. It can use this information to help determine the first measurement system.

The system then uses an analog sensor 30 mounted on the robotic arm 20 to take multiple measurements of at least one of the outer and inner surfaces 102, 103 of the hollow root end and continually updates the root center approximately 182 until the deviation between root center falls below a specified number and the actual center 180 is found. Exemplary centers in FIG. 15 182a, 182m and 182z show estimates based upon the corresponding measurements 184a, 184m and 184z, showing the estimated center 182 approaching the actual center 180.

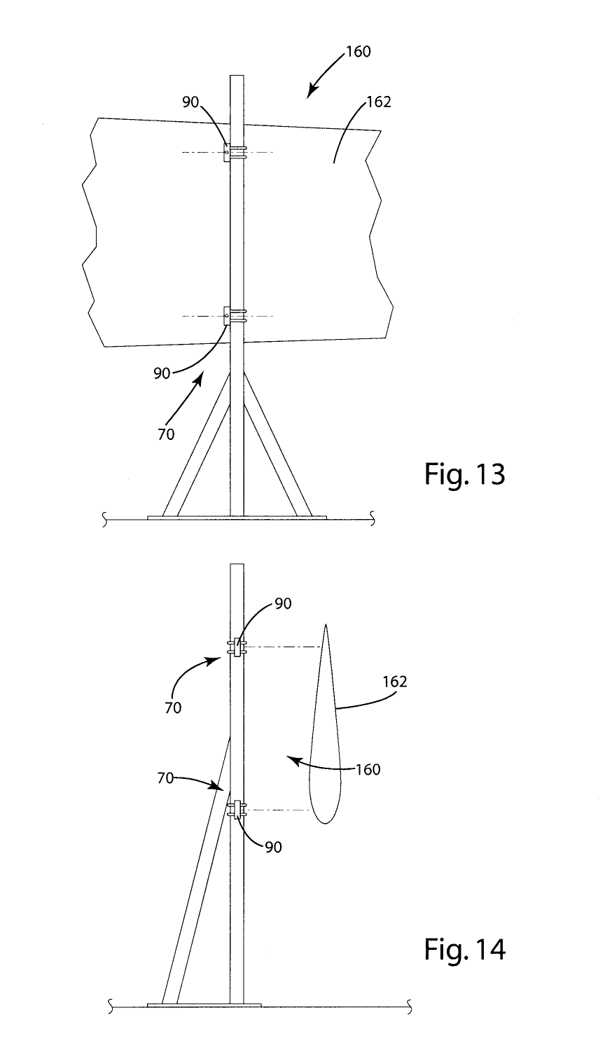

As the workpiece has a three-dimensional shape, it is desirable to determine the twist, if any of the workpiece and compensate for such twist in particular while processing the root end. The sensor array 90, illustrated in FIGS. 13 and 14 as an analog laser sensor array determines the offset angle from a zero pitch axis. The system typically performs this measurement after tip measurement and before root end center determination, but it can be completed in any order. If the measurements show that the workpiece is outside of tolerances such that the robot cannot start machining, the operator is informed.

The system then computes the measurements to determine a root sawing operation to form the desired hub attachment surface 171, without the need to adjust the workpiece 160. The root sawing operation is performed by an abrasive saw and face mill tool and creates the hub attachment surface 171. More specifically, the system determines a hub attachment surface that prevents too much material from being removed, and ensures an accurate and precise location of the hub surface as compared to the master part by aligning the system's view of the workpiece with the data from the master workpiece, thereby eliminating the need to physically adjust the actual workpiece, and is important to maintain the proper balance. The hub surface 171 may then be further machined such as by grinding to the exact specifications.

Once the hub attachment surface 171 is formed, the system performs axial hole drilling operations to create the bolt holes 176, and then radial hole drilling operations to form the cross member holes 178. Of course, these operations may be switched in order.

In the method for finding tip 190 using a 3-D vision system, the tip location is found by taking an average of current blade tip and comparing with a stored average. This comparison yields a reference and thus an offset from the mater tip location. This offset from the master tip location is used to determine the current tip location. The camera may be over the expected location of the tip to establish a rough location then this rough location is used to determine the final tip portion. In regards to the 3-D laser mapping device, a 3-D range is formed by 3-D laser profiling device. This image is averaged and then also compared to a stored average. Form the comparison, the location as well as the twist of the blade may be determined.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A method of performing a manufacturing operation on an elongated workpiece having an outer circumference and an inner circumference at a root end using a robotic assembly, said robotic assembly including a robotic arm, a first remote sensor capable of sensing twist and a second remote sensor, at least one sensor located on said robotic arm, and a controller, said method comprising the steps of:
directing the sensor on the robotic arm to a first measurement position based upon an expected location of a first location of at least one of the outer circumference and an inner circumference of the workpiece;
sensing the actual location of the first location on the workpiece using the sensor on the robotic arm;
communicating the output of the sensor on the robotic arm to the controller to determine the actual location of the first location of the workpiece;
determining with the controller an expected location of a second location on at least one of the outer circumference and inner circumference of the workpiece using the actual location of the first location on the workpiece;
moving the sensor on the robotic arm to a second measurement position, said second measurement position being determined by the expected location of the second location of the workpiece;
sensing the actual location of the second location on the workpiece using the sensor on the robotic arm;
communicating the sensor output of the sensor on the robotic arm to the controller to determine the actual location of the second surface of the workpiece;
calculating the actual root end center of the elongated workpiece;
determining the twist of the workpiece; and
determining the location of tip of the elongated workpiece.

2. The method of claim 1, further including after said step of providing the sensor output to the controller to determine the actual location of the second location of the workpiece, the step of determining the expected location of a third location on the workpiece and moving the sensor on the robotic arm to a third measurement position, the third measurement position being determined by the expected location of the third location.

3. The method of claim 1, wherein the sensor on the robotic arm takes at least three additional measurements of the surface of said workpiece before said step of determining the root end center of the workpiece.

4. The method of claim 3 said method includes the step of determining an expected root center after each measurement of the surface of said at least additional measurements of the surface.

5. The method of claim 4 wherein said step of determining the actual root center includes the step of comparing the last expected root center to the previous expected root center before the last expected root center and selecting the current expected root center as the actual root center when the difference between said last expected root center and the previous expected root center falls below a predetermined amount.

6. The method of claim 1 wherein following said step of sensing the actual location of the first location on the workpiece using the sensor on the robotic arm, the controller determines the offset of the actual location of the first location from an expected location along a first axis.

7. The method of claim 1 wherein following said step of sensing the actual location of the first surface of the workpiece using the sensor on the robotic arm, the controller determines the offset of the actual location of the first location from an expected location along the X and Y axes.

8. The method of claim 1 wherein following said step of sensing the actual location of the second location of the workpiece using the sensor on the robotic arm, the controller determines the offset of the actual location of the first location of the second location along the X and Y axis.

9. The method of claim 1 further including the step of determining a radial finished surface about said actual root center based upon said step of determining the twist of the workpiece and said step of determining an actual root center.

10. The method of claim 9 further including the step of radially sawing said workpiece about said root center at a predetermined distance from said radial finished surface.

11. The method of claim 10 further including the step of machining said radially sawn workpiece approximately to said radial finished surface.

12. The method of claim 11 wherein said workpiece includes an axis approximately aligned with said actual root center and wherein said method further includes the step of drilling axial cavities substantially aligned with said axis.

13. The method of claim 12 further including the step of drilling radial holes that intersect said axial cavities and wherein each of said radial holes includes an axis that substantially intersects the axis of the other radial holes at approximately said actual root center.

14. The method of claim 11 wherein said workpiece includes an axis approximately aligned with said actual root center and wherein said method further includes the step of drilling radial holes that include an axis that substantially intersects the axis of the other radial holes at approximately said root center.

15. The method of claim 14 further including the step of drilling axial cavities substantially aligned with said axis and wherein said cavities intersect said radial holes.

16. The method of claim 1 wherein said step of determining twist includes the step of determining the rotation offset of the workpiece from a predetermined zero pitch offset.

17. The method of claim 1 wherein said step of determining the location of the tip includes the step of providing a 3D visualization system and locating the tip within a specified range using said 3D visualization system.

18. The method of claim 17 wherein said sensor for determining twist is located between said 3D visualization sensor and said robotic arm.

19. A method of performing a manufacturing operation on a wind turbine blade having a longitudinal axis, a tip, an outer circumferential surface, an inner circumferential surface defining a cavity, and a root end, using a robotic assembly, said robotic assembly including a robotic arm, a first remote sensor capable of sensing twist and a second remote sensor, at least one sensor located on said robotic arm, and a controller, said method comprising the steps of:
directing the sensor on the robotic arm proximate to a first measurement position proximate to the root end based upon an expected location of one of said outer circumferential surface and said inner circumferential surface;
sensing the actual location of a first location on the at least one of the outer circumferential surface and the inner circumferential surface proximate to the root end using the sensor on the robotic arm;
moving the sensor on the robotic arm proximate to a second measurement position;
sensing the actual location of a second location;
determining a first estimated root end center based upon the actual location of the first and second locations;
continue measuring additional locations on at least one of the surface of the outer circumference and the surface of the inner circumference;
determining based upon said additional locations additional estimated root end centers, until the last estimated root end center is within a specified tolerance level;
determining the twist of the workpiece; and
determining the location of tip of the elongated workpiece.

20. The method of claim 19 wherein said step of determining based upon said additional locations additional estimated root end centers, until the last estimated root end center is within a specified tolerance level further includes the step of determining the difference between the last estimated root end center and the estimated root end center previous to said last estimated root end center is less than a predetermined amount.

21. The method of claim 19 further including the step of determining a hub surface after determining the location of the tip of the elongated work surface.

22. The method of claim 21 further including the step of sawing said workpiece parallel to said hub surface.

23. The method of claim 22 further including the step of machining said workpiece.

24. The method of claim 23 further including the step of determining an estimated root center following each determining actual location of the workpiece using the sensor on the robotic arm.

25. A method of performing a manufacturing operation on a wind turbine blade having a longitudinal axis, a tip, an outer circumferential surface, an inner circumferential surface defining a cavity, and a root end using a robotic assembly, said robotic assembly including a robotic arm, a first remote sensor capable of sensing twist and a second remote sensor, at least one sensor located on said robotic arm, and a controller, said method comprising the steps of:
determining the twist of the workpiece using said first sensor;
determining the location of the tip of the workpiece using said second sensor;
determining an estimated location of one of the outer and inner circumferential surfaces using said determined twist and determined location of the tip of the workpiece;
directing the sensor on the robotic arm proximate to a first measurement position proximate to the root end based upon said the determined estimated location of one of the outer and inner circumferential surfaces;
sensing the actual location of the a first location on the at least one of the outer circumferential surface and the inner circumferential surface proximate to the root end using the sensor on the robotic arm;
determining with the controller an expected location of a second measurement position on one of the outer circumferential surface and the inner circumferential surface of the blade proximate the root end using the actual location of the first location;
moving the sensor on the robotic arm proximate to the second measurement position;
sensing the actual location of the second measurement position;
determining a first estimated root end center based upon the actual location of the first and second measurement locations;
continue measuring additional locations on at least one of the surface of the outer circumference and the surface of the inner circumference; and
determining based upon each of said additional locations additional estimated root end centers, until the last estimated root end center is within a specified tolerance level.

26. The method of claim 25 further including the step of determining a radial finished surface about said actual root center based upon said step of determining the twist of the workpiece and said step of determining an actual root center.

27. The method of claim 26 further including the step of radially sawing said workpiece about said root center at a predetermined distance from said radial finished surface.

28. The method of claim 27 further including the step of machining said radially sawn workpiece approximately to said radial finished surface.

29. The method of claim 28 wherein said workpiece includes an axis approximately aligned with said actual root center and wherein said method further includes the step of drilling axial cavities substantially aligned with said axis.

30. The method of claim 29 further including the step of drilling radial holes that intersect said axial cavities and wherein each of said radial holes includes an axis that substantially intersects the axis of the other radial holes at approximately said actual root center.

31. The method of claim 28 wherein said workpiece includes an axis approximately aligned with said actual root center and wherein said method further includes the step of drilling radial holes that include an axis that substantially intersects the axis of the other radial holes at approximately said root center.

32. The method of claim 31 further including the step of drilling axial cavities substantially aligned with said axis and wherein said cavities intersect said radial holes.

33. The method of claim 25 wherein said step of determining twist includes the step of determining the rotation offset of the workpiece from a predetermined zero pitch offset.

34. The method of claim 25 wherein said step of determining the location of the tip includes the step of providing a 3D visualization system and locating the tip within a specified range using said 3D visualization system.

35. The method of claim 34 wherein said sensor for determining twist is located between said 3D visualization sensor and said robotic arm.
